(19) United States
(12) Patent Application Publication
(10) Pub. No.: US 2022/0338674 A1
(43) Pub. Date: Oct. 27, 2022

(54) BARBECUING APPARATUS

(71) Applicant: Keesung Manufacturing Co., Ltd, Guangzhou City, Guangdong Province (CN)

(72) Inventors: Qingbin HE, Guangzhou City, Guangdong Province (CN); Baozhong Xiao, Guangzhou City, Guangdong Province (CN)

(21) Appl. No.: 17/420,713

(22) PCT Filed: Sep. 10, 2020
(86) PCT No.: PCT/CN2020/114456

§ 371 Date: Jul. 5, 2021

(30) Foreign Application Priority Data
Aug. 24, 2020 (CN) 202021779220.6

(51) Int. Cl. A47J 37/07

(52) U.S. Cl. CPC A47J 37/0713; A47J 37/0786

(57) ABSTRACT

Disclosed is a barbecuing apparatus which belongs to the field of structure design. The barbecuing apparatus comprises a grill and a grill plate arranged above the grill. The grill is provided with an accommodation cavity, and the grill plate covers the accommodation cavity and is detachably connected with the grill. The grill plate is provided with an oil leak hole and the grill is provided with an oil discharge hole at a bottom of the accommodation cavity. An oil discharge pipe is connected between the oil leak hole and the oil discharge hole. A side of the oil discharge hole far away from the oil discharge pipe is provided with a grease cup. By covering the accommodation cavity of the grill with the grill plate, forming the oil leak hole in the grill plate and forming the oil discharge hole at the bottom of the accommodation cavity, redundant oil in the barbecuing apparatus is drained to the grease cup via an oil discharge pipe which connects the oil leak hole with the oil discharge hole, thereby preventing the oil from splashing or flowing out of the barbecuing apparatus and from being contacted with a user, such that the potential safety hazard is eliminated. Meanwhile, it is easier to clean a product therefrom, thereby playing a role of protecting environmental health.

### CLAIM OF PRIORITY

The application claims the priority of Chinese Patent Application No. 202021779220.6 filed on Aug. 24, 2020 and entitled ‘barbecuing apparatus’ in the Patent Office of the People's Republic of China, the entire disclosure of which is incorporated herein by reference.

### TECHNICAL FIELD

The application relates to the field of structure design, in particular to a barbecuing apparatus.

### BACKGROUND

With development of street vending economy, barbecuing becomes one of projects many people work on. A barbecue grill is an indispensable tool for barbecuing and the barbecue grill is primarily divided into three types: a charcoal grill, a gas grill and an electric grill.

However, it is needed to brush oil to food or to oil the grill plate whatever barbecue grill barbecues food. As oil is liable to flow, the oil is easy to splash or flow out of the barbecue grill to be in contact with a user to further lead to hurt to the user, thereby bringing potential safety hazards and bringing a problem of difficulty in cleaning.

### SUMMARY

An object of the application is to provide a barbecuing apparatus to solve the problem that oil in an existing barbecuing apparatus is liable to splash or flow out.

In order to achieve the purpose, the application adopts a technical scheme as follows:

a barbecuing apparatus includes a grill and a grill plate arranged above the grill, wherein the grill is provided with an accommodation cavity, and the grill plate covers the accommodation cavity and is detachably connected with the grill;

the grill plate is provided with an oil leak hole and the grill is provided with an oil discharge hole at a bottom of the accommodation cavity, and an oil discharge pipe is connected between the oil leak hole and the oil discharge hole; and

a side of the oil discharge hole far away from the oil discharge pipe is provided with a grease cup.

Optionally, an end of the oil discharge pipe connected with the oil leak hole is provided with a funnel-shaped oil receiving bucket in a protruding manner, and the oil receiving bucket is embedded into the oil leak hole and is fixedly connected with the grill plate.

Optionally, the grill is further fixedly connected with a carrying rack for carrying the grease cup, and the grease cup abuts against the carrying rack.

Optionally, the carrying rack includes a fixing portion and a clamping portion, the fixing portion is fixedly connected with the grill, a position of the grill corresponding to the clamping portion is provided with a limiting groove, and the clamping portion is in clamping connection with the limiting groove; and

a carrying portion is integrally formed between the fixing portion and the clamping portion, a position of the grease cup corresponding to the carrying portion is provided with a protruding block in a protruding manner, and the protruding block abuts against the carrying portion.

Optionally, the grill is rotatably connected with a lid.

Optionally, a side of the grill plate facing the grill is provided with a clamping block in a protruding manner, and a position of the grill corresponding to the clamping block is provided with a clamping groove in clamping connection with the clamping block.

Optionally, the bottom of the ill is connected with a foldable moving apparatus.

Optionally, the moving apparatus includes two wheel racks, and the two wheel racks are arranged on two sides of the grill plate respectively and are rotatably connected with the grill plate; and

one end of each of the wheel racks far away from the grill plate are rotatably connected with two casters arranged at an interval.

Optionally, each of the wheel racks is provided with a pressing type buckle and the grill corresponding to the pressing type buckle is provided with a limiting clamping block.

Optionally, a supporting plate is detachably arranged between the two wheel racks.

Compared with the prior art, the application has the following beneficial effects:

According to the barbecuing apparatus provided by the application, by covering the accommodation cavity of the grill with the grill plate, forming the oil leak hole in the grill plate and forming the oil discharge hole at the bottom of the accommodation cavity, redundant oil in the barbecuing apparatus is drained to the grease cup via an oil discharge pipe which connects the oil leak hole with the oil discharge hole, the oil is prevented from splashing or flowing, out of the barbecuing apparatus, and the oil is prevented from being contacted with a user, such that the potential safety hazard is eliminated.

### BRIEF DESCRIPTION OF THE DRAWINGS

In order to describe the embodiments of the application or the technical scheme in the prior art more clearly, brief introduction on drawings needed to be used in the embodiment will be made below. It is obvious that the drawings described below are some embodiments of the application, and those skilled in the technical field farther can obtain other drawings according to the drawings without creative efforts.

Structure, proportion, size and the like shown by the drawings of the description are only used for matching with contents disclosed by the description to be understood and read by those skilled in the field rather than limiting applicable limitation, conditions of the application. Thus, structure, proportion, size and the like do not have technical substantive meaning. Any structural modification, change of proportional relations or adjustment of size shall fall within the scope covered by the technical content disclosed by the application without affecting functions which can be generated and purposes which can be achieved.

FIG. 1 is a first exploded structural schematic diagram of the barbecuing apparatus provided by the embodiment of the application;

FIG. 2 is a second exploded structural schematic diagram of the barbecuing apparatus provided by the embodiment of the application;

FIG. 3 is a schematic diagram of a connection between the grill plate and the grill of the embodiment of the application;

FIG. 4 is a structural schematic diagram of the grill plate of the embodiment of the application;

FIG. 5 is a structural schematic diagram of a connection between the grill plate and the oil discharge pipe of the embodiment of the present invention;

FIG. 6 is a structural schematic diagram of the carrying rack of the embodiment of the present invention;

FIG. 7 is a first connecting structural schematic diagram of the grill and the moving apparatus of the embodiment of the application;

FIG. 8 is a second connecting structural schematic diagram of the grill and the moving apparatus of the embodiment of the application;

FIG. 9 is a structural schematic diagram of the pressing type buckle of the embodiment of the present invention.

In the drawings, 1, grill, 11, accommodation cavity, 12, oil discharge hole, 13, clamping groove, 14, limiting clamping block, 2, grill plate, 21, oil leak hole, 22, lid, 23, clamping block, 3, oil discharge pipe, 31, oil receiving bucket, 4, grease cup, 5, carrying rack, 51, fixing portion, 52, clamping portion, 53, carrying portion, 6, moving apparatus, 61, wheel rack, 62, caster, 7, pressing type buckle.

### DETAILED DESCRIPTION

In order to make purposes, characteristics and advantages of the application clearer and more understandable, clear and intact description will be made on technical scheme in the embodiment of the application below in combination with drawings in the embodiment of the application. It is obvious that the described embodiments are merely a part of embodiments of the application and are not all the embodiments. On a basis of the embodiments in the disclosure, all other embodiments obtained by those skilled in the technical field without creative efforts fall into the scope of protection of the application.

In description of the application, it should be understood that orientation or position relationships indicated by terms: ‘upper, ‘lower’ ‘top’, ‘bottom’, ‘inner’, ‘outer’ and the like are orientation or position relationships indicated by the drawings and are only to describe the disclosure and simplify the description rather than indicates or implies that the indicated, device or components must have specific orientations and are configured and operated in the specific orientations. Therefore, it cannot be construed as limitations to the application. It should be noted that when one, assembly is regarded as, being connected with another assembly, the assembly can be directly connected to another assembly or an assembly arranged in the center may exist as well.

The technical scheme of the application is further described through specific embodiments in combination with the drawings.

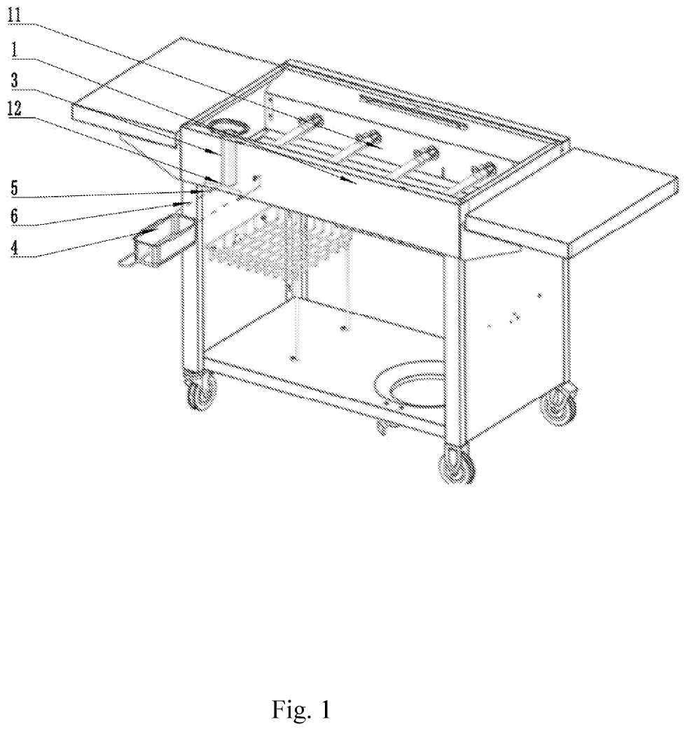

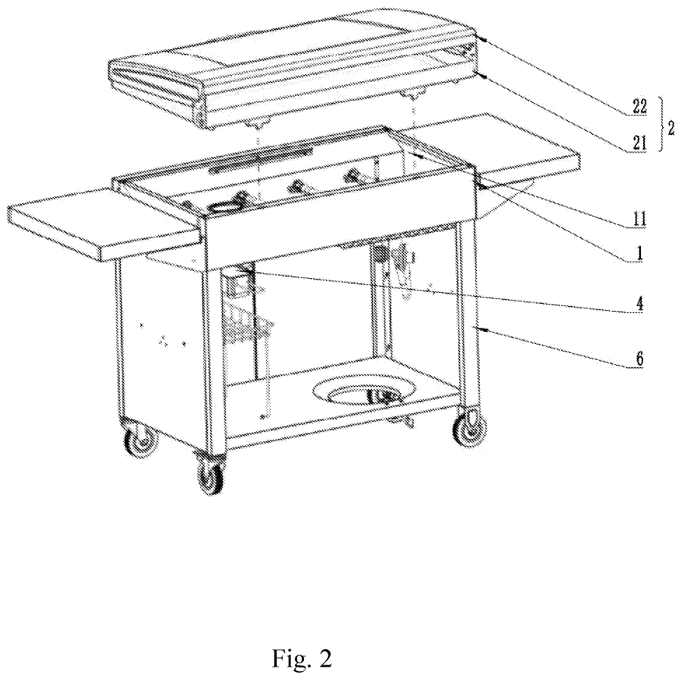

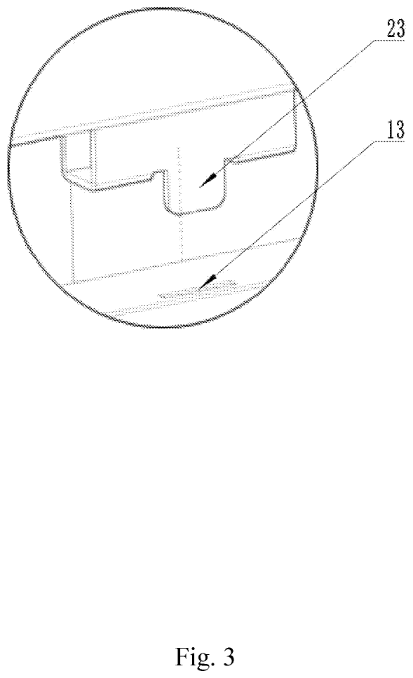

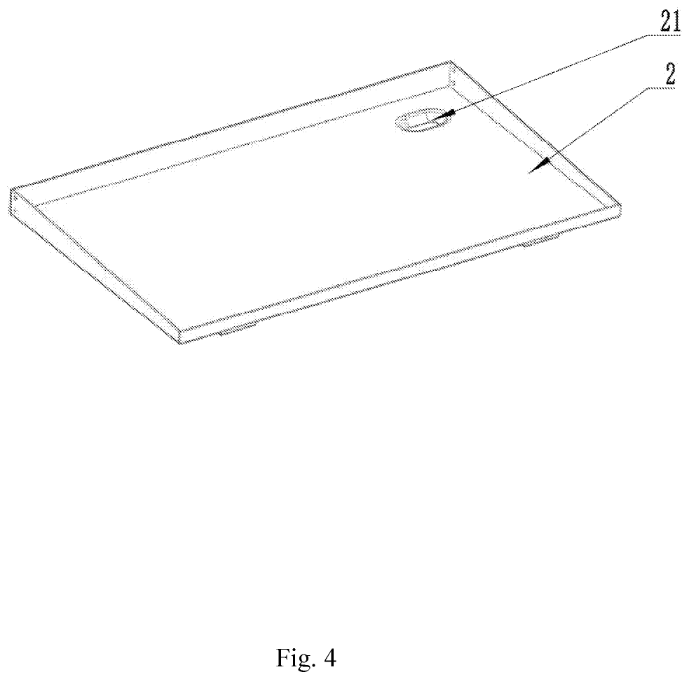

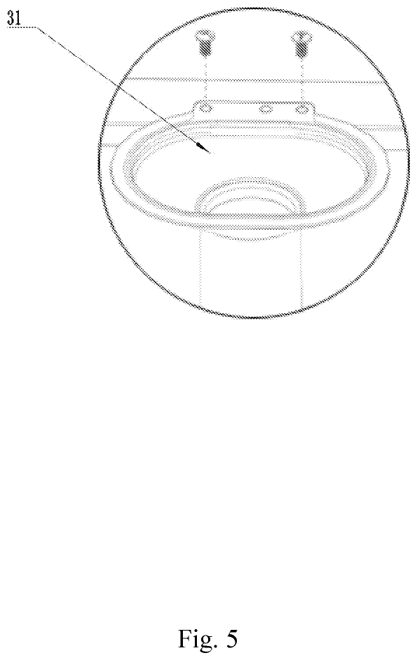

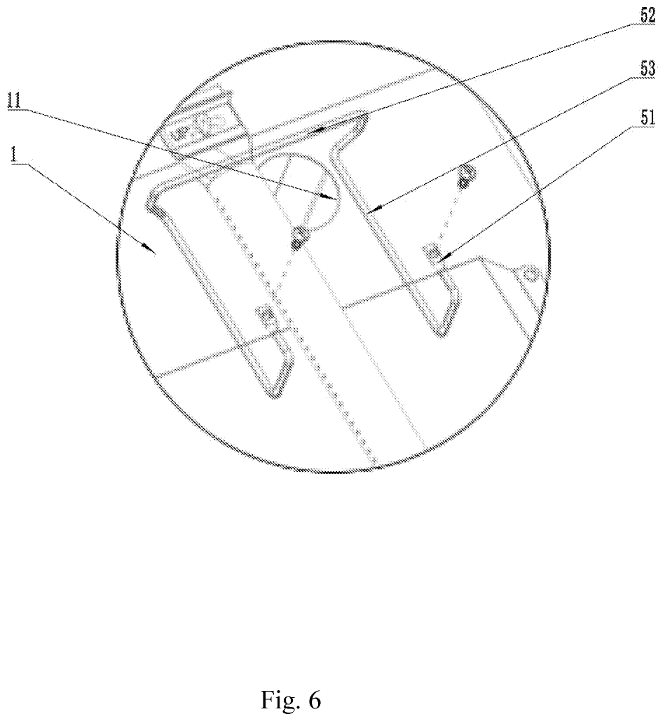

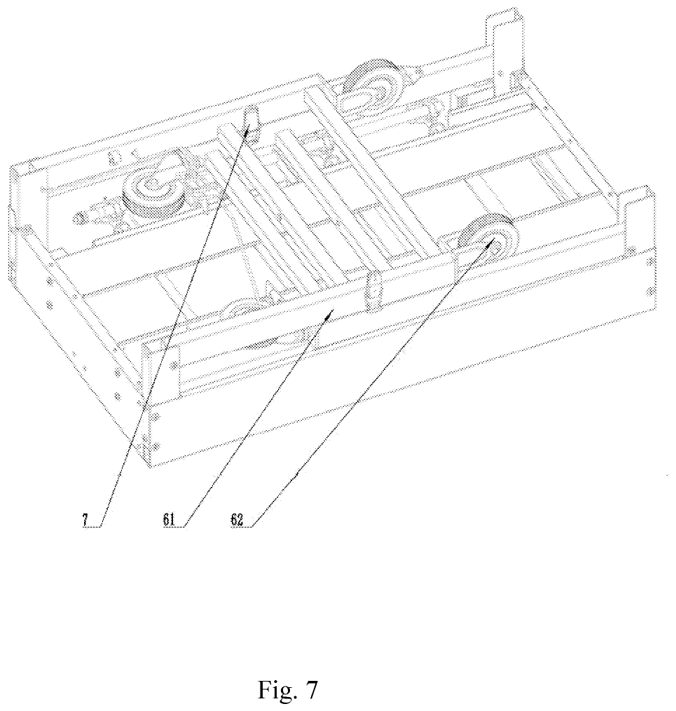

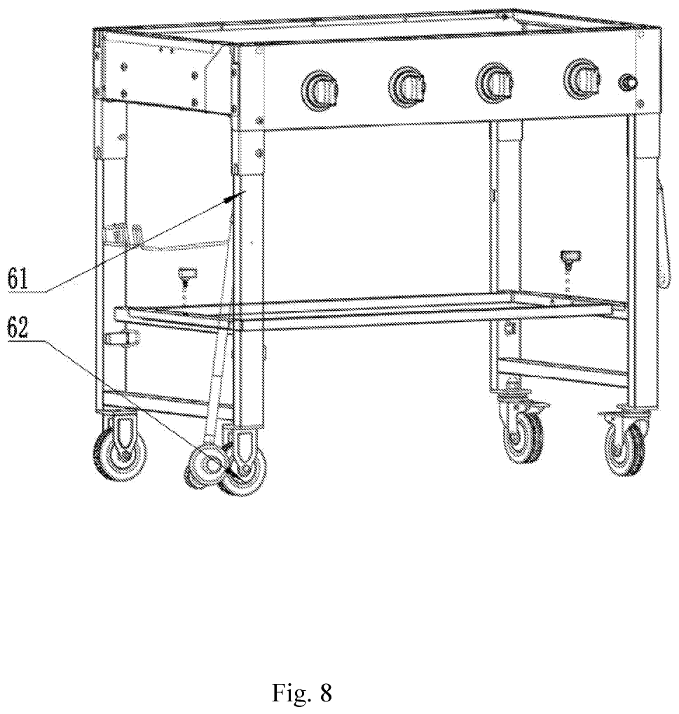

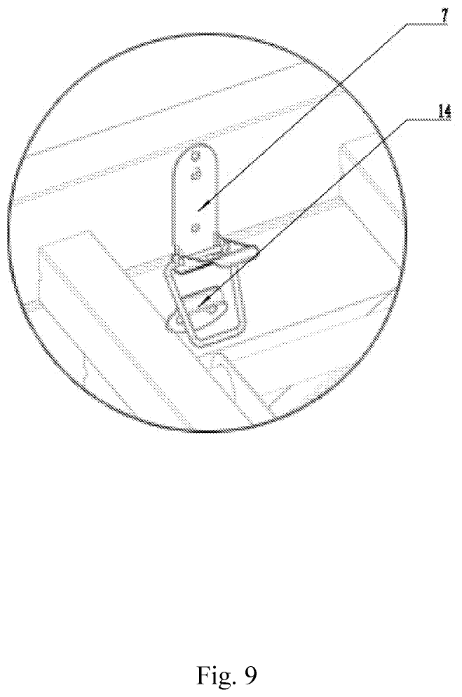

Referring to FIG. 1 to FIG. 9, FIG. 1 is the first exploded structural schematic diagram of the barbecuing apparatus provided by the embodiment of the application; FIG. 2 is the second exploded structural schematic diagram of the barbecuing apparatus provided by the embodiment of the application; FIG. 3 is the schematic diagram of the connection between the grill plate and the grill of the embodiment of the application; FIG. 4 is the structural schematic diagram of the grill plate of the embodiment of the application; FIG. 5 is the structural schematic diagram of a connection between the grill plate and the oil discharge pipe of the embodiment of the present invention; FIG. 6 is the structural schematic diagram of the carrying rack of the embodiment of the present invention; FIG. 7 is the first connecting structural schematic diagram of the grill and the moving apparatus of the embodiment of the application; FIG. 8 is the second connecting structural schematic diagram of the grill and the moving apparatus of the embodiment of the application; and FIG. 9 is the structural schematic diagram of the pressing type buckle of the embodiment of the present invention.

The barbecuing apparatus provided by the embodiment conducts barbecuing by way of gas combustion. Combustible gas is introduced to barbecue food materials via an air throttle, and the structure is improved, so that a condition that oil splashes to hurt the user is avoided and the potential safety hazards are eliminated.

As shown in the FIG. 1 and FIG. 2, the embodiment provides a barbecuing apparatus, including a grill 1 and a grill plate 2 arranged above the grill 1.

The grill 1 is provided with an accommodation cavity 11, and the grill plate 2 covers the accommodation cavity 11 and is detachably connected with the grill 1.

The grill plate 2 is provided with an oil leak hole 21 and the grill 1 is provided with an oil discharge hole 12 at a bottom of the accommodation cavity 11, and an oil discharge pipe 3 is connected between the oil leak hole 21 and the oil discharge hole 12.

A side of the oil discharge hole 12 far away from the oil discharge pipe 3 is provided with a grease cup 4.

By covering the accommodation cavity 11 of the grill 1 with the grill plate 2, forming the oil leak hole 21 in the grill plate 2 and forming the oil discharge hole 12 at the bottom of the accommodation cavity 11, redundant oil in the barbecuing apparatus is drained to the grease cup 4 via an oil discharge pipe 3 which connects the oil leak hole 21 with the oil discharge hole 12, the oil is prevented from splashing or flowing out of the barbecuing apparatus, and the oil is prevented from being contacted with a user, such that the potential safety hazard is eliminated. Specifically, the grease cup 4 is further arranged below the grill 1 and can prevent the oil from being splashed or scattered to the ground as the user touches the grease cup 4 mistakenly effectively, so that the safety is further improved.

Further, as shown in the FIG. 3, a side of the grill plate 2 facing the grill 1 is provided with a clamping block 23 in a protruding manner, and a position of the grill 1 corresponding to the clamping block 23 is provided with a clamping groove 13 in clamping connection with the clamping block 23. When it is needed to arrange the grill plate 2 on the grill 1, the clamping block 23 is aligned with the clamping groove 13, such that on the one hand, it is convenient to mount and position the grill 1 and on the other hand, the mounting stability of the barbecuing apparatus is improved.

Further, as shown in the FIG. 4 and FIG. 5, an end of the oil discharge pipe 3 connected with the oil leak hole 21 is provided with a funnel-shaped oil receiving bucket 31 in a protruding manner, and the oil receiving bucket 31 is embedded into the oil leak hole 21 and is fixedly connected with the grill plate 2, wherein the oil receiving bucket 31 is fixedly connected with the grill plate 2 via bolts. By arranging the funnel-shaped oil receiving bucket 31, the oil can flow into the oil discharge pipe 3 slowly, such that the oil is prevented from being splashed.

Further, as shown in the FIG. 6, the grill 1 is further fixedly connected with a carrying rack 5 for carrying the grease cup 4, and the grease cup 4 abuts against the carrying rack 5.

Specifically, the carrying rack 5 includes a fixing portion 51 and a clamping portion 52, the fixing portion 51 is fixedly connected with the grill 1, and the fixing portion 51 is fixedly connected with the grill 1 via bolts; a position of the grill 1 corresponding to the clamping portion 52 is provided with a limiting groove, and the clamping portion 52 is in clamping connection with the limiting groove.

A carrying portion 53 is integrally formed between the fixing portion 51 and the clamping portion 52, a position of the grease cup 4 corresponding to the carrying portion 53 is provided with a protruding block in a protruding manner, and the protruding block abuts against the carrying portion 53. The fixing portion 51 is fixed from two sides, so that the fastening degree is high. The clamping portion 52 is clamped in the limiting groove and is less limited in degree of freedom along a horizontal direction. The grease cup 4 can be taken out from the carrying, rack 5 by way of deforming the clamping portion 52, such that it is convenient for the user to clean the grease cup 4.

Further, as shown in the FIG. 2, the grill plate 1 is rotatably connected with a lid 22, wherein the grill plate 2 is rotatably connected with the lid 22 via a hinge. The lid 22 plays a role of sealing the grill plate 2.

On the basis of the embodiments, as shown in the FIG. 7 and FIG. 8, the bottom of the grill 1 is connected with the foldable moving apparatus 6. It should be further noted that the bottom of the grill 1 further can be connected with moving apparatuses 6 of other different types, for example, the moving apparatuses 6 can be either frames which are welded and formed and are provided with, driven wheels or frames which are connected and formed by aluminum profiles and fasteners and are provided with driven wheels or frames formed by casting, the frames being connected with driving wheels with driving apparatuses.

Further, as shown in the FIG. 7, the moving apparatus 6 includes two wheel racks 61, and the two wheel racks 61 are arranged on two sides of the grill plate 2 respectively and are rotatably connected with the grill plate 2.

One end of each of the wheel racks 61 far away from the grill plate 2 are rotatably connected with two casters 62 arranged at an interval.

Further, as shown in the FIG. 7 and FIG. 9, each of the wheel racks 61 is provided with a pressing type buckle 7 and the grill 1 corresponding to the pressing type buckle 7 is provided with a limiting clamping block 14. Specifically, when it is needed to store the barbecuing apparatus, the wheel rack 61 is rotated along a direction close to the grill 1 and is locked in the limiting clamping block 14 via the pressing type buckle 7.

In a specific embodiment, as shown in the FIG. 8, a supporting plate is detachably arranged between the two wheel racks 61. By arranging the supporting plate, the wheel racks 61 can be prevented from rotating toward the direction close to the grill 1 under the action of an external force after the wheel racks are unfolded, such that the stability and safety of the barbecuing apparatus are improved.

In a word, the barbecuing apparatus provided by the embodiment can avoid a condition that the oil is splashed or scattered to the ground effectively to eliminate the potential safety hazard, such that the user experience is improved.

In conclusion, the above embodiments are only used to explain the technical scheme of the application and shall not be construed as limitation. Despite reference to the aforementioned embodiments to make a detailed description for the application, it will be understood by those skilled in the art that they still can modify the technical scheme recorded by the aforementioned embodiments or make equivalent substitutions on part of technical features therein. Such modifications or substitutions do not deviate the nature of the technical scheme from the spirit and scope of the technical scheme embodied in the embodiments according to the application.

1. A barbecuing apparatus, characterized by comprising a grill (1) and a grill plate (2) arranged above the grill (1), wherein
the grill (1) is provided with an accommodation cavity (11), and the grill plate (2) covers the accommodation cavity (11) and is detachably connected with the grill (1);
the grill plate (2) is provided with an oil leak hole (21) and the grill (1) is provided with an oil discharge hole (12) at a bottom of the accommodation cavity (11), and an oil discharge pipe (3) is connected between the oil leak hole (21) and the oil discharge hole (12); and
a side of the oil discharge hole (12) far away from the oil discharge pipe (3) is provided with a grease cup (4).

2. The barbecuing apparatus according to claim 1, characterized, in that an end of the oil discharge pipe (3) connected with the oil leak hole (21) is provided with a funnel-shaped oil receiving bucket (31) in a protruding manner, and the oil receiving bucket (31) is embedded into the oil leak hole (21) and is fixedly connected with the grill plate (2).

3. The barbecuing apparatus according to claim 1, characterized in that the grill (1) is further fixedly connected with a carrying rack (5) for carrying the grease cup (4), and the grease cup (4) abuts against the carrying rack (5).

4. The barbecuing apparatus according to claim 1, characterized in that the carrying rack (5) comprises a fixing portion (51) and a clamping portion (52), the fixing portion (51) is fixedly connected with the grill (1), a position of the grill (1) corresponding to the clamping portion (52) is provided with a limiting groove, and the clamping portion (52) is in clamping connection with the limiting groove; and
a carrying portion (53) is integrally formed between the fixing portion (51) and the clamping portion (52), a position of the grease cup (4) corresponding to the carrying portion (53) is provided with a protruding block in a protruding manner, and the protruding block abuts against the carrying portion (53).

5. The barbecuing apparatus according to claim 1, characterized in that the grill (3) is rotatably connected with a lid (22).

6. The barbecuing apparatus according to claim 1, characterized in that a side of the grill plate (2) facing the grill (1) is provided with a clamping block (23) in a protruding manner, and a position of the grill (1) corresponding to the clamping block (23) is provided, with a clamping groove (13) in clamping connection with the clamping block (23).

7. The barbecuing apparatus according to claim 1, characterized in that a bottom of the grill (1) is connected with a foldable moving apparatus (6).

8. The barbecuing apparatus according to claim 7, characterized in that the moving apparatus (6) comprises two wheel racks (61), and the two wheel racks (61) are arranged on two sides of the grill plate (2) respectively and are rotatably connected with the grill plate (2); and
one end of each of the wheel racks (61) far away from the grill plate (2) are rotatably connected with two casters (62) arranged at an interval.

9. The barbecuing apparatus according to claim 8, characterized in that each of the wheel racks (61) is provided with a pressing type buckle (7) and the grill (1) corresponding to the pressing type buckle (7) is provided with a limiting clamping block (14).

10. The barbecuing apparatus according to claim 8, characterized in that a supporting plate is detachably arranged between the two wheel racks (61).
